(19) United States
(12) Patent Application Publication
(10) Pub. No.: US 2023/0236878 A1
(43) Pub. Date: Jul. 27, 2023

(54) EFFICIENTLY LAUNCHING TASKS ON A PROCESSOR

(71) Applicant: NVIDIA CORPORATION, Santa Clara, CA (US)

(72) Inventors: Jack Hilaire CHOQUETTE, Palo Alto, CA (US); Rajballav DASH, San Jose, CA (US); Shayani DEB, Seattle, WA (US); Gentaro HIROTA, San Jose, CA (US); Ronny M. KRASHINSKY, San Francisco, CA (US); Ze LONG, Santa Clara, CA (US); Chen MEI, Shanghai (CN); Manan PATEL, San Jose, CA (US); Ming Y. SIU, Santa Clara, CA (US)

(21) Appl. No.: 17/583,957

(22) Filed: Jan. 25, 2022

(51) Int. Cl. G06F 9/48

(52) U.S. Cl. CPC G06F 9/4881

(57) ABSTRACT

In various embodiments, scheduling dependencies associated with tasks executed on a processor are decoupled from data dependencies associated with the tasks. Before the completion of a first task that is executing in the processor, a scheduling dependency specifying that a second task is dependent on the first task is resolved based on a pre-exit trigger. In response to the resolution of the scheduling dependency, the second task is launched on the processor.

### BACKGROUND

### Field of the Various Embodiments

The various embodiments relate generally to parallel processing systems and, more specifically, to efficiently launching tasks on a processor.

### Description of the Related Art

Parallel processors are capable of very high processing performance using a large number of threads executing in parallel on dedicated programmable hardware processing units. Some parallel processors provide programming platform software stacks that enable software applications executing under the control of a primary processor or “host” to access a parallel processor or “device” as a black box via calls to one or more application programming interfaces (“APIs”). Each such software application typically makes API calls to offload various tasks to a parallel processor. One problematic aspect of offloading tasks to parallel processors is that each task can be a “consumer” task that is dependent on one or more other related “producer” tasks, a producer task upon which one or more related consumer tasks depend, both a consumer task and a producer task, or neither a consumer task nor a producer task.

In one approach to executing tasks, a parallel processor ensures that all of the threads executing a producer task have finished executing and any data generated by the threads is copied or “flushed” to a shared memory before scheduling any threads to execute any related consumer tasks. In this fashion, the parallel processor resolves all possible scheduling dependencies and all possible data dependencies between each producer task and the related consumer tasks. An example of a scheduling dependency is when a producer task is required to start before a related consumer task can start. An example of a data dependency is when an output of a producer task is consumed by a related consumer task.

One drawback associated with the above approach is that a parallel processor ends up performing the memory flushes and numerous other time-consuming “overhead” operations after the last thread of a producer task has finished executing and before initiating the execution of or “launching” a related consumer task. As a result, the overall time required to execute a software application can be substantially increased. The length of time a parallel processor spends performing overhead operations after the last thread of a producer task has finished executing and the first thread of a related consumer task begins executing is referred to herein as “launch latency.” Major contributors to launch latency can include, without limitation, synchronizing and performing memory flushes across processing units, processing scheduling data for the consumer task, and scheduling and load balancing the consumer task across processing units. In many cases, the launch latency between producer tasks and related consumer tasks remains relatively constant irrespective of the time required to actually execute the tasks. Consequently, for software applications that include tasks having relatively short execution times (e.g., many deep learning software applications), the launch latencies can be comparable to or even exceed the time needed to execute the tasks.

As the foregoing illustrates, what is needed in the art are more effective techniques for executing tasks on parallel processors.

### SUMMARY

One embodiment sets forth a parallel processor. The parallel processor includes a set of multiprocessors and a work scheduler/distribution unit coupled to the set of multiprocessors that, launches a first task on a first subset of the plurality of multiprocessors; prior to launching a second task, determines that a first scheduling dependency associated with the second task is unresolved, where the first scheduling dependency specifies that the second task is dependent on the first task; before the completion of the first task, resolves the first scheduling dependency based on a pre-exit trigger; and in response to the resolution of the first scheduling dependency, launches the second task on a second subset of the set of multiprocessors.

At least one technical advantage of the disclosed techniques relative to the prior art is that, with the disclosed techniques, a processor can schedule, launch, and execute an initial portion of a consumer task while continuing to execute a related producer task. In that regard, with the disclosed techniques, scheduling dependencies can not only be decoupled from data dependencies but can also be resolved during the execution of producer tasks. Furthermore, with the disclosed techniques, data dependencies can be resolved during the execution of consumer tasks. Resolving dependencies during instead of between the execution of tasks allows the execution of consumer tasks, producer tasks, and associated overhead instructions to be overlapped. As a result, launch latencies and therefore the overall time required to execute software applications can be reduced. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a system configured to implement one or more aspects of the various embodiments;

FIG. 2 is a more detailed illustration of the parallel processor of FIG. 1, according to various embodiments;

FIG. 3 is an example illustration of a critical path associated with executing a producer task and a related consumer task on the parallel processor of FIG. 2, according to various embodiments; and

FIG. 4 is a flow diagram of method steps for executing a task on a parallel processor, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes only, multiple instances of like objects are denoted herein with reference numbers identifying the object and parenthetical alphanumeric character(s) identifying the instance where needed.

### Exemplary System Overview

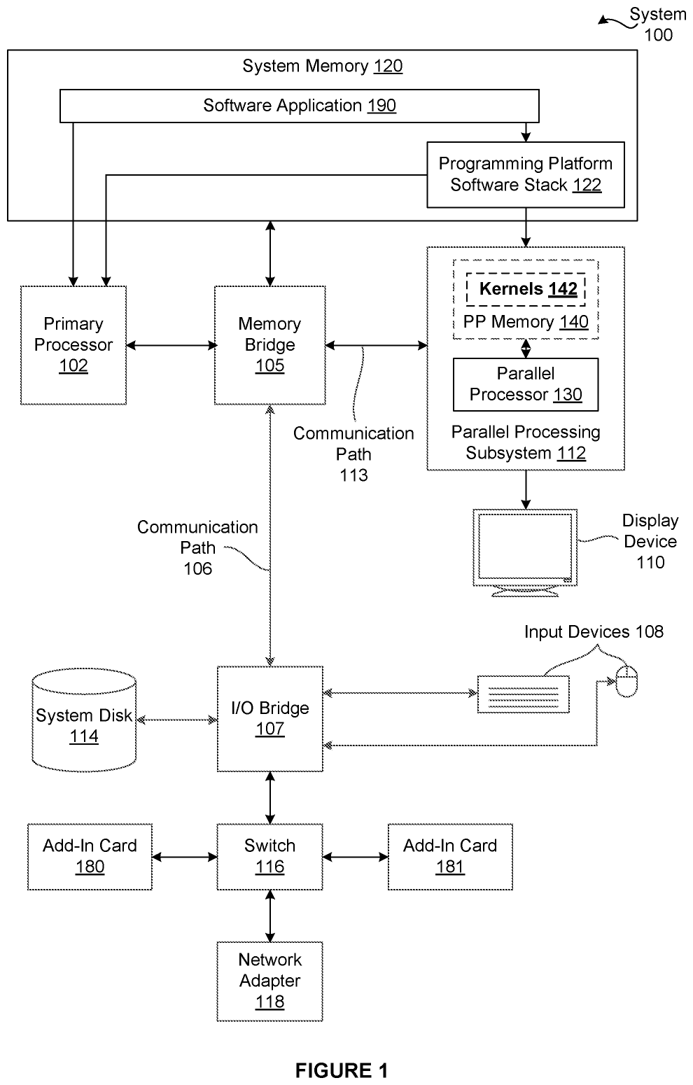

FIG. 1 is a block diagram illustrating a system 100 configured to implement one or more aspects of the various embodiments. As shown, the system 100 includes, without limitation, a primary processor 102 and a system memory 120 coupled to a parallel processing subsystem 112 via a memory bridge 105 and a communication path 113. The primary processor 102 can be any type of processor that is capable of launching kernels on a parallel processor. As referred to herein, a “processor” can be any instruction execution system, apparatus, or device capable of executing instructions. In some embodiments, the primary processor is a latency-optimized general-purpose processor, such as a central processing unit (CPU).

In some embodiments, at least a portion of the system memory 120 is host memory associated with the primary processor 102. The memory bridge 105 is further coupled to an input/output (I/O) bridge 107 via a communication path 106, and the I/O bridge 107 is, in turn, coupled to a switch 116.

In operation, the I/O bridge 107 is configured to receive user input information from input devices 108, such as a keyboard or a mouse, and forward the input information to the primary processor for processing via the communication path 106 and the memory bridge 105. The switch 116 is configured to provide connections between the I/O bridge 107 and other components of the system 100, such as a network adapter 118 and add-in cards 180 and 181.

As also shown, the I/O bridge 107 is coupled to a system disk 114 that can be configured to store content, applications, and data for use by the primary processor and the parallel processing subsystem 112. As a general matter, the system disk 114 provides non-volatile storage for applications and data and can include fixed or removable hard disk drives, flash memory devices, compact disc read-only memory, digital versatile disc read-only memory, Blu-ray, high definition digital versatile disc, or other magnetic, optical, or solid-state storage devices. Finally, although not explicitly shown, other components, such as a universal serial bus or other port connections, compact disc drives, digital versatile disc drives, film recording devices, and the like, can be connected to the I/O bridge 107 as well.

In various embodiments, the memory bridge 105 can be a Northbridge chip, and the I/O bridge 107 can be a Southbridge chip. In addition, the communication paths 106 and 113, as well as other communication paths within the system 100, can be implemented using any technically suitable protocols, including, without limitation, Peripheral Component Interconnect Express, Accelerated Graphics Port, HyperTransport, or any other bus or point-to-point communication protocol known in the art.

In some embodiments, the parallel processing subsystem 112 incorporates circuitry optimized for general-purpose processing. Such circuitry can be incorporated across one or more parallel processors that can be configured to perform general-purpose processing operations. As referred to herein, a “parallel processor” can be any computing system that includes, without limitation, multiple parallel processing elements that can be configured to perform any number and/or types of computations. And a “parallel processing element” of a computing system is a physical unit of simultaneous execution in the computing system

In the same or other embodiments, the parallel processing subsystem 112 further incorporates circuitry optimized for graphics processing. Such circuitry can be incorporated across one or more parallel processors that can be configured to perform graphics processing operations. In the same or other embodiments, any number of parallel processors can output data to any number of display devices, such as the display device 110. In some embodiments, zero or more parallel processors can be configured to perform general-purpose processing operations but not graphics processing operations, zero or more parallel processors can be configured to perform graphics processing operations but not general-purpose processing operations, and zero or more parallel processors can be configured to perform general-purpose processing operations and/or graphics processing operations. In some embodiments, software applications executing under the control of the primary processor 102 can launch kernels on one or more parallel processors included in the parallel processing subsystem 112.

In some embodiments, the parallel processing subsystem 112 is implemented as an add-in card that can be inserted into an expansion slot of the system 100. In some other embodiments, the parallel processing subsystem 112 can be integrated with one or more other elements of FIG. 1 to form a single system. For example, the parallel processing subsystem 112 can be integrated with the primary processor and other connection circuitry on a single chip to form a system on a chip. In the same or other embodiments, any number of primary processors 102 and any number of parallel processing subsystems 112 can be distributed across any number of shared geographic locations and/or any number of different geographic locations and/or implemented in one or more cloud computing environments (i.e., encapsulated shared resources, software, data, etc.) in any combination.

In some embodiments, the parallel processing subsystem 112 includes, without limitation, a parallel processor 130, parallel processing (PP) memory 140, zero or more other parallel processors (not shown), and zero or more other PP memories (not shown). The parallel processor 130, the PP memory 140, zero or more other parallel processors, and zero or more other PP memories can be implemented using one or more integrated circuit devices, such as programmable processors, application-specific integrated circuits, or memory devices, or in any other technically feasible fashion.

The parallel processor 130 can be any type of parallel processor. In some embodiments, the parallel processor 130 can be a parallel processing unit (PPU), a graphics processing unit (GPU), a tensor processing unit, a multi-core CPU, an intelligence processing unit, a neural processing unit, a neural network processor, a data processing unit, a vision processing unit, or any other type of processor or accelerator that can presently or in the future support parallel execution of multiple threads. As used herein, a “thread” refers to an instance of a particular program executing on a particular set of input data. The parallel processor 130 can be identical to zero or more other parallel processors included in the parallel processing subsystem 112 and different from zero or more other parallel processors included in the parallel processing subsystem 112.

In some embodiments, the parallel processor 130 can be integrated on a single chip with a bus bridge, such as the memory bridge 105 or the I/O bridge 107. In some other embodiments, some or all of the elements of the parallel processor 130 can be included along with the primary processor 102 in a single integrated circuit or system on a chip.

The PP memory 140 includes, without limitation, any number and/or types of memories and/or storage devices that are dedicated to the parallel processor 130. In some embodiments, the PP memory 140 includes, without limitation, one or more dynamic random access memories (DRAMs). In some embodiments, the PP memory 140 is also referred to as the “device memory” associated with the parallel processor 130. In the same or other embodiments, kernels 142 that are executed on the parallel processor 130 reside in the PP memory 140. Each of the kernels 142 is a set of instructions (e.g., a program, a function, etc.) that can execute on the parallel processor 130.

In some embodiments, the parallel processor 130 is not associated with dedicated memory, the PP memory 140 is omitted from the parallel processing subsystem 112, and the parallel processor 130 can use any number and/or types of memories and/or storage devices in any technically feasible fashion. In the same or other embodiments, each of any number of other parallel processors can be associated with dedicated PP memory or no dedicated PP memory.

The system memory 120 can include, without limitation, any amount and/or types of system software (e.g., operating systems, device drivers, library programs, utility programs, etc.), any number and/or types of software applications, or any combination thereof. The system software and the software applications included in the system memory 120 can be organized in any technically feasible fashion.

As shown, in some embodiments, the system memory 120 includes, without limitation, a programming platform software stack 122 and a software application 190. The programming platform software stack 122 is associated with a programming platform for leveraging hardware in the parallel processing subsystem 112 to accelerate computational tasks. In some embodiments, the programming platform is accessible to software developers through, without limitation, libraries, compiler directives, and/or extensions to programming languages. In the same or other embodiments, the programming platform can be, but is not limited to, Compute Unified Device Architecture (“CUDA”) (CUDA® is developed by NVIDIA Corporation of Santa Clara, Calif.), Radeon Open Compute Platform (“ROCm”), OpenCL (OpenCL™ is developed by Khronos group), SYCL, or Intel One API.

In some embodiments, the programming platform software stack 122 provides an execution environment for the software application 190 and zero or more other software applications (not shown). In some embodiments, the software application 190 can be any type of software application that resides in any number and/or types of memories and executes any number and/or types of instructions on the primary processor 102 and/or any number and/or types of instructions on the parallel processing subsystem 112. The software application 190 can execute any number and/or types of instructions on the parallel processing subsystem 112 in any technically feasible fashion. For instance, in some embodiments, the software application 190 can include, without limitation, any computer software capable of being launched on the programming platform software stack 122.

In some embodiments, the software application 190 and the programming platform software stack 122 execute under the control of the primary processor 102. In the same or other embodiments, the software application 190 can access that parallel processor 130 and any number of other parallel processors included in the parallel processing subsystem 112 via the programming platform software stack 122. In some embodiments, the programming platform software stack 122 includes, without limitation, any number and/or types of libraries (not shown), any number and/or types of runtimes (not shown), any number and/or types of drivers (not shown), or any combination thereof.

In some embodiments, each library can include, without limitation, data and programming code that can be used by computer programs (e.g., the software application 190, any number of the kernels 142, etc.) and leveraged during software development. In the same or other embodiments, each library can include, without limitation, pre-written code, kernels, subroutines, functions, macros, any number and/or types of other sets of instructions, or any combination thereof that are optimized for execution on the parallel processor 130. In the same or other embodiments, libraries included in the programming platform software stack 122 can include, without limitation, classes, values, type specifications, configuration data, documentation, or any combination thereof. In some embodiments, the libraries are associated with one or more application programming interfaces (API) that expose at least a portion of the content implemented in the libraries.

In some embodiments, at least one device driver is configured to manage the processing operations of the one or more parallel processors within the parallel processing subsystem 112. In the same or other embodiments, any number of device drivers implement API functionality that enables software applications to specify instructions for execution on the one or more parallel processors via API calls. In some embodiments, any number of device drivers provide compilation functionality for generating machine code specifically optimized for the parallel processing subsystem 112.

In the same or other embodiments, at least one runtime includes, without limitation, any technically feasible runtime system that can support execution of the software application 190 and zero or more other software applications. In some embodiments, the runtime is implemented as one or more libraries associated with one or more runtime APIs. In the same or other embodiments, one or more drivers are implemented as libraries that are associated with driver APIs.

In some embodiments, one or more runtime APIs and/or one or more driver APIs can expose, without limitation, any number of functions for each of memory management, execution control, device management, error handling, and synchronization, and the like. The memory management functions can include but are not limited to functions to allocate, deallocate, and copy device memory, as well as transfer data between host memory and device memory. The execution control functions can include but are not limited to functions to launch kernels on parallel processors included in the parallel processing subsystems 112. In some embodiments, relative to the runtime API(s), the driver API(s) are lower-level APIs that provide more fine-grained control of the parallel processors.

In some embodiments, the software application 190 and zero or more other software applications (not shown) can reside in any number of memories and execute on any number of processors in any combination. In the same or other embodiments, the software application 190 and zero or more other software applications use the programming platform software stack 122 to offload tasks from the primary processor 102 to the parallel processor 130 and zero or more other parallel processors. A software application can use the programming platform software stack 122 to offload a task from a primary processor to a parallel processor in any technically feasible fashion.

In some embodiments, the software application 190 offloads a task from the primary processor 102 to the parallel processor 130 via an API call referred to as a kernel invocation (not shown). The kernel invocation includes, without limitation, the name of a kernel, an execution configuration (not shown), and zero or more argument values (not shown) for arguments of the kernel. In some embodiments, the execution configuration specifies, without limitation, a configuration (e.g., size, dimensions, etc.) of a batch of threads. The batch of threads can be organized in any technically feasible fashion, and the execution configuration can be specified in any technically feasible fashion. In response to a kernel invocation, the parallel processor 130 configures each thread in a batch having the specified configuration to execute a different instance of the specified kernel on a different set of data as per any specified argument values.

In some embodiments, each task can be a “consumer” task that is dependent on one or more other related “producer” tasks, a producer task upon which one or more related consumer tasks depend, both a consumer task and a producer task, or neither a consumer task nor a producer task. Note that each task can be a consumer task that depends on zero or more related producer tasks, a producer task upon which one or more related consumer tasks depend, both a consumer task and a producer task, or neither a consumer task nor a producer task. Furthermore, each task can have a scheduling dependency, a data dependency, or both on each related consumer task, and each related consumer task can have a scheduling dependency, a data dependency, or both on the task. Scheduling dependencies and data dependencies between tasks can be specified in any technically feasible fashion.

For instance, in some embodiments, the software application 190 makes calls to a CUDA graph API to generate a CUDA graph that specifies scheduling dependencies and data dependencies between tasks. In the same or other embodiments, the software application 190 can use CUDA steams, a framework for data analytics and/or machine learning (e.g., RAPIDS), or any number of DirectX mechanisms to define chains of dependent tasks. In some embodiments, any number and/or types of drivers, any number and/or types of runtimes, or any combination thereof can derive data dependencies and scheduling dependencies between tasks in any technically feasible fashion.

Note that the techniques described herein are illustrative rather than restrictive and may be altered without departing from the broader spirit and scope of the various embodiments. Many modifications and variations on the functionality provided by the system 100, the primary processor 102, the parallel processing subsystem 112, the parallel processor 130, the PP memory 140, the software application 190, the kernels 142, the programming platform software stack 122, zero or more libraries, zero or more drivers, and zero or more runtimes will be apparent to those of ordinary skill in the art without departing from the scope and spirit of the described embodiments.

It will be appreciated that the system shown herein is illustrative and that variations and modifications are possible. The connection topology, including the number and arrangement of bridges, the number of the primary processors 102, and the number of the parallel processing subsystems 112, can be modified as desired. For example, in some embodiments, the system memory 120 is not directly connected to the memory bridge 105, and other devices can communicate with the system memory 120 via the memory bridge 105 and the primary processor 102. In some other embodiments, the parallel processing subsystem 112 can be connected to the I/O bridge 107 or directly to the primary processor 102, rather than to the memory bridge 105. In still other embodiments, the I/O bridge 107 and the memory bridge 105 can be integrated into a single chip instead of existing as one or more discrete devices. Lastly, in some embodiments, one or more components shown in FIG. 1 may not be present. For example, the switch 116 could be eliminated, and the network adapter 118 and the add-in cards 180, 181 would connect directly to the I/O bridge 107.

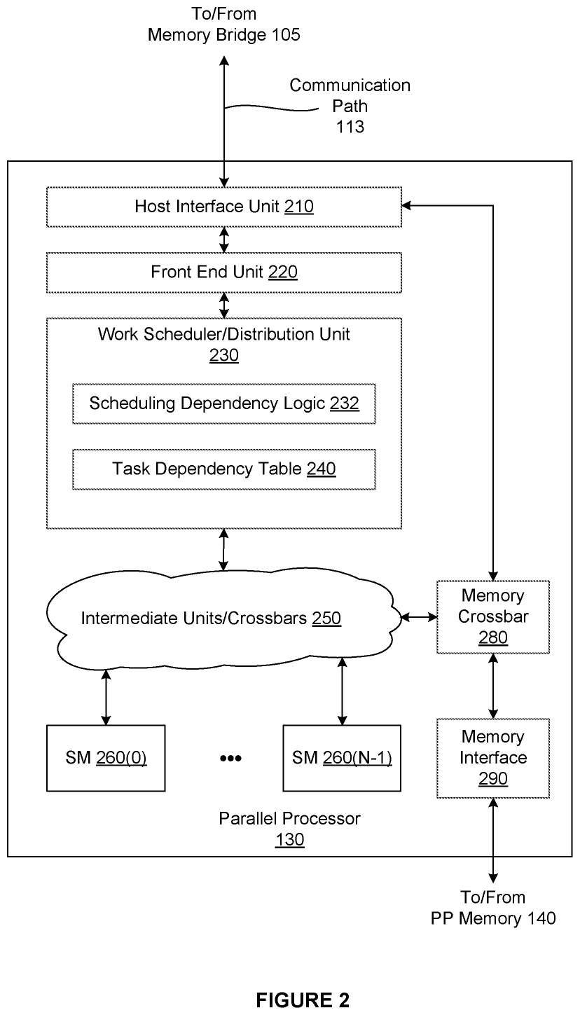

FIG. 2 is a more detailed illustration of the parallel processor 130 of FIG. 1, according to various embodiments. As shown, the parallel processor 130 incorporates circuitry optimized for general-purpose processing, and the parallel processor 130 can be configured to perform general-purpose processing operations. Although not shown in FIG. 2, in some embodiments, the parallel processor 130 is a GPU and further incorporates circuitry optimized for graphics processing, including, for example, video output circuitry. In such embodiments, the parallel processor 130 can be configured to perform general-purpose processing operations, graphics processing operations, or both.

Referring again to FIG. 1 as well as FIG. 2, in some embodiments, the primary processor 102 is the master processor of the system 100, controlling and coordinating operations of other system components. In some embodiments, the parallel processor 130 can be programmed to execute tasks relating to a wide variety of software applications and/or algorithms. In some embodiments, the parallel processor 130 is configured to transfer data from the system memory 120 and/or the PP memory 140 to one or more on-chip memory units, process the data, and write result data back to the system memory 120 and/or the PP memory 140. The result data can then be accessed by other system components, including the primary processor 102, another parallel processor within the parallel processing subsystem 112, or another parallel processing subsystem 112 within the system 100.

The primary processor 102 can issue commands that control the operation of the parallel processor 130 in any technically feasible fashion. In some embodiments, the primary processor 102 writes a stream of commands for the parallel processor 130 to a data structure (not explicitly shown in either FIG. 1 or FIG. 2) that can be located in the system memory 120, the PP memory 140, or another storage location accessible to both the primary processor 102 and the parallel processor 130.

A pointer to the data structure is written to a pushbuffer to initiate processing of the stream of commands in the data structure. The parallel processor 130 reads command streams from the pushbuffer and then executes commands asynchronously relative to the operation of the primary processor 102. In embodiments where multiple pushbuffers are generated, execution priorities can be specified for each pushbuffer by a software application via a device driver (not shown) to control the scheduling of the different pushbuffers.

In some embodiments, tasks are encoded as task descriptors (not shown), the task descriptors are stored in memory, and pointers to the task descriptors are included in one or more command streams. In the same or other embodiments, tasks that can be encoded as task descriptors include, without limitation, indices associated with the data to be processed as well as state parameters and commands that define how the data is to be processed. For example, the state parameters and commands could define one of the kernels 142 to be executed on the data and zero or more argument values for arguments of the kernel. Also, for example, each task descriptor could specify the configuration of a batch of threads that is to execute the task. In some embodiments, each task descriptor can optionally specify, without limitation scheduling dependencies, data dependencies, any type of dependency-related data (e.g., a total number of related consumer tasks, a total number of related producer tasks, etc.), or any combination thereof.

Referring back now to FIG. 2, in some embodiments, the parallel processor 130 includes, without limitation, a host interface unit 210, a memory crossbar 280, a memory interface 290, a front end unit 220, a work scheduler/distribution unit 230, intermediate units/crossbars 250, and streaming multiprocessors (SMs) 260(0)-260(N−1), where N can be any positive integer. For explanatory purposes, the SMs 260(0)-260(N−1) are also referred to herein individually as “SM 260” and collectively as “SMs 260.”

In some embodiments, the host interface unit 210 communicates with the rest of system 100 via the communication path 113, which connects to the memory bridge 105. In some other embodiments, the host interface unit 210 communicates with the rest of system 100 via the communication path 113, which connects directly to the primary processor 102. In some embodiments, the connection of the parallel processor 130 to the rest of the system 100 can be varied. In some embodiments, the host interface unit 210 implements a Peripheral Component Interconnect Express (PCIe) interface for communications to the system 100 over a PCIe bus. In the same or other embodiments, the host interface unit 210 can implement any number and/or types of interfaces for communicating with any number and/or types of external devices.

In some embodiments, the host interface unit 210 generates packets (or other signals) for transmission on the communication path 113 and also receives all incoming packets (or other signals) from the communication path 113. In some embodiments, the host interface unit 210 decodes incoming packets, directing the incoming packets to appropriate components of the parallel processor 130. In the same or other embodiments, the host interface unit 210 reads one or more command streams from one or more pushbuffers and directs the commands from the command stream(s) to the appropriate components of the parallel processor 130. In some embodiments, the host interface unit 210 directs commands related to processing tasks to the front end unit 220, and commands related to memory operations (e.g., reading from or writing to the PP memory 140) to the memory crossbar 280.

In some embodiments, the front end unit 220 manages commands related to tasks, reading commands, and forwarding commands to various units of the parallel processor 130. In the same or other embodiments, the front end unit 220 forwards commands specifying tasks (e.g., pointers to task descriptors) to the work scheduler/distribution unit 230.

In some embodiments, the work scheduler/distribution unit 230 receives commands specifying tasks (e.g., pointers to task descriptors) and manages the execution of the specified tasks on the SMs 260. The work scheduler/distribution unit 230 can receive any number and/or types of commands specifying tasks from the front end unit 220. In some embodiments, the work scheduler/distribution unit 230 can also receive any number and/or types of commands specifying consumer tasks issued from related producer tasks executing on any number of the SMs 260.

In some embodiments, the work scheduler/distribution unit 230 performs any number and/or types of operations to cause the SMs 310 to properly execute the specified tasks. For explanatory purposes, the functionality of the parallel processor 130 is described herein in the context of some embodiments in which the work scheduler/distribution unit 230 causes one or more SMs 260 to each process one or more groups of threads or “thread blocks” in a grid of thread blocks to execute a task.

Note, however, that the techniques described herein are illustrative rather than restrictive and can be altered without departing from the broader spirit and scope of the various embodiments. Many modifications and variations on the functionality provided by the work scheduler/distribution unit 230 and the SMs 260 will be apparent to those of ordinary skill in the art without departing from the scope and spirit of the described embodiments.

Referring back to FIG. 1, in some embodiments, each batch of threads is a grid of thread blocks. In the same or other embodiments, each kernel invocation includes, without limitation, the name of a kernel, an execution configuration specifying a configuration of a grid of thread blocks, and zero or more argument values for arguments of the kernels. In some embodiments, the execution configuration specifies, without limitation, a single-dimensional or multi-dimensional grid size and a single-dimensional or multi-dimensional thread block size. The grid size specifies the number of thread blocks that are to be included in the grid of thread blocks. The thread block size specifies the number of threads that are to be included in each thread block.

In some embodiments, each thread in a grid of thread blocks executes a different instance of the same kernel on different input data to execute an associated task. In the same or other embodiments, each of the thread blocks in a grid of thread blocks can execute independently of the other threads blocks in the grid of thread blocks. In some embodiments, to execute a task (e.g., in response to a kernel invocation), the work scheduler/distribution unit 230 launches each of the thread blocks in a corresponding grid of thread blocks onto one of the SMs 260 for processing. The work scheduler/distribution unit 230 can configure the SMs 260 and/or communicate with the SMs 260 in any technically feasible fashion.

As shown, in some embodiments, the work scheduler/distribution unit 230 and the SMs 260 are connected via the intermediate units/crossbars 250. The intermediate units/crossbars 250 include, without limitation, any number and/or types of units in a processing hierarchy, any number and/or types of units in a memory (including cache) hierarchy, any number and/or types of units and/or communication paths for routing information, or any combination thereof between various units in the parallel processor 130 and/or the PP memory 140, or any combination thereof. In some embodiments, the functionality described herein with respect to the work scheduler/distribution unit 230 can be distributed across the work scheduler/distribution unit 230 and one or more units included in the intermediate units/crossbars 250.

For instance, in some embodiments, the intermediate units/crossbars 250 include, without limitation, any number of modular pipe control units (MPCs) that are included in the processing hierarchy. Each MPC is a resource manager for a different set of one or more SMs 260. Each MPC acts as an intermediary between an associated set of SMs 260 and the work scheduler/distribution unit 230. The techniques and functionality described herein with respect to the work scheduler/distribution unit 230 and the SMs 260 can be modified, implemented, and distributed across the work scheduler/distribution unit 230, the MPCs, and the SMs 260 accordingly.

In some embodiments, any number and/or types of caches in a cache hierarchy associated with the parallel processor 130 are distributed across the SMs 260, the intermediate units/crossbars 250, the memory interface 290, or any combination thereof. Although not shown, each SM 260 contains a level one (L1) cache or uses space in a corresponding L1 cache included in the intermediate units/crossbars 250 to support, among other things, load and store operations performed by execution units. In some embodiments, one or more level one-point-five (“L1.5”) caches can be configured to receive and hold data requested from memory 150 (e.g., via the memory crossbar 280 and the memory interface 290) by one or more groups of SMs 260. Such data can include, without limitation, instructions, uniform data, and constant data. In the same or other embodiments, different groups of SMs 260 can beneficially share common instructions and data cached in different L1.5 caches. In some embodiments, the intermediate units/crossbars 250 enable each SM 260 to access one or more level two (L2) caches that are shared among all the SMs 260 in the parallel processor 130. In the same or other embodiments, the L2 cache(s) can be used to transfer data between threads. In some embodiments, the L2 cache(s) are the point of coherency for the parallel processor 130.

In some embodiments, each SM 260 is configured to process one or more thread blocks. In the same or other embodiments, each SM 260 breaks each thread block into one or more groups of parallel threads referred to as “warps.” In some embodiments, each warp includes, without limitation, a fixed number of threads (e.g., 32). Each warp of a given thread block concurrently executes the same kernel on different input data, and each thread in a warp concurrently executes the same kernel on different input data. In some embodiments, each SM 260 can concurrently process a maximum number of thread blocks (e.g., one, two, etc.) that is dependent on the size of the thread blocks.

In some embodiments, each SM 260 implements single-instruction, multiple-thread (SIMT) to support parallel execution of a large number of threads without providing multiple independent instruction units. In some other embodiments, single-instruction, multiple-thread (SIMT) techniques are used to support parallel execution of a large number of generally synchronized threads, using a common instruction unit configured to issue instructions to a set of processing engines within the parallel processor 130. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In some embodiments, each SM 260 implements a Single-Instruction, Multiple-Data (SIMD) architecture where each thread in a warp is configured to process a different set of data based on the same set of instructions. All threads in the warp execute the same instructions. In some other embodiments, each SM 260 implements a Single-Instruction, Multiple Thread (SIMT) architecture where each thread in a warp is configured to process a different set of data based on the same set of instructions, but where individual threads in the warp are allowed to diverge during execution. In other words, when an instruction for the warp is dispatched for execution, some threads in the warp may be active, thereby executing the instruction, while other threads in the warp may be inactive, thereby performing a no—operation instead of executing the instruction. Persons of ordinary skill in the art will understand that a SIMD architecture represents a functional subset of a SIMT architecture.

In some embodiments, each SM 260 includes, without limitation, a set of execution units (not shown). In the same or other embodiments, each execution unit is a parallel processing element. Processing operations specific to any of the execution units can be pipelined, which enables a new instruction to be issued for execution before a previous instruction has completed execution. Any combination of execution units within a given SM 260 can be provided. In various embodiments, the execution units can be configured to support a variety of different operations including integer and floating-point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same execution unit can be configured to perform different operations.

As described previously herein, one problematic aspect of offloading tasks to parallel processors is that each task can be a consumer task that is dependent on one or more other related producer tasks, a producer task upon which one or more related consumer tasks depend, both a consumer task and a producer task, or neither a consumer task nor a producer task. In a conventional approach to executing tasks, a conventional parallel processor ensures that all of the thread blocks of a producer task have finished executing and any data generated by the thread blocks is flushed to a memory that is accessible to all SMs before scheduling any thread blocks to execute any related consumer tasks. More specifically, after the thread blocks executing a producer task have finished executing, a conventional parallel processor executes a “memory flush” for a producer task. The memory flush flushes any data generated by the thread blocks to the point of coherency for the parallel processor, such as L2 cache(s). The length of time between when the last thread block of a producer task has finished executing and the first thread block of a related consumer task begins executing is referred to herein as the “launch latency” between the producer task and the related consumer task.

One drawback associated with conventional parallel processors is that the launch latencies for many software applications can be prohibitive. For instance, in one conventional approach to executing tasks, after receiving notifications of thread block completions from all “producer” SMs executing the thread blocks of a producer task, a conventional work scheduler/distribution unit broadcasts a memory flush request to the producer SMs. In response to the memory flush request, each producer SM performs a memory flush. After receiving notifications of memory flush completions from all producer SMs, the conventional work scheduler/distribution unit performs one or more task completion operations. Subsequently, the conventional work scheduler/distribution unit performs scheduling information processing operations to process scheduling information for the related consumer task. The conventional work scheduler/distribution unit then performs scheduling/load balancing operations to schedule and load balance the workload associated with the related consumer task across one or more “consumer” SMs. Subsequently, the conventional work scheduler/distribution unit performs a task launch that launches the thread blocks of the related consumer task onto the consumer SMs as scheduled.

For explanatory purposes, the thread block completion, the memory flush request, and the task completion for the producer task are also referred to herein as “producer overhead operations.” And the scheduling information processing operations, the scheduling load/balancing operations, and the thread block launch for the related consumer task are also referred to herein as “consumer overhead operations.” In many conventional approaches, the launch latency between the producer task and the related consumer task is equal to the sum of the latencies of the producer overhead operations for the producer task and the consumer overhead operations for the related consumer task. In practice, the launch latencies associated with executing software applications on conventional processors can be comparable to—and can even exceed—the time required to execute the associated tasks. Launch latencies can therefore substantially increase the overall time required to execute software applications on conventional parallel processors.

### Decoupling Scheduling and Data Dependencies

In some embodiments, to reduce launch latencies and therefore the overall time required to execute software applications, the parallel processor 130 decouples any scheduling dependency between a producer task and a related consumer task from any data dependency between the producer task and the related consumer task. As a result, the parallel processor 130 can execute consumer overhead operations and a data-independent portion of the related consumer task after the scheduling dependency is resolved irrespective of any data dependency between the producer task and the related consumer task. As referred to herein, a “data-independent portion” of a consumer task is at least an initial portion (e.g., an initial subset of instructions) of the consumer task that does not require any data generated by any related producer task(s). A data-independent portion of a task is also referred to herein as a “data-independent set of instructions.” If a consumer task does not have any data dependencies on any related producer tasks, then the data-independent portion of the consumer task is the entire consumer task.

In some embodiments, upon determining that all scheduling dependencies that a consumer task has on related producer tasks are released, the work scheduler/distribution unit 230 executes consumer overhead operations for the consumer task that cause one or more of the SMs 260 to execute the data-independent portion of the consumer task. More specifically, in some embodiments, the work scheduler/distribution unit 230 sequentially executes scheduling information processing operations, scheduling load/balancing operations, and a thread block launch that causes one or more SMs 260 to execute the consumer task.

Executing a “thread block launch” that causes one or more SMs 260 to execute a given task is also referred to herein as “launching” that task on the one or more SMs 260. The work scheduler/distribution unit 230 can execute a thread block launch in any technically feasible fashion. In some embodiments, the work scheduler/distribution unit 230 executes the thread block launch for a given task based on a task descriptor for the task.

Accordingly, decoupling scheduling dependencies from data dependencies can allow overlapped execution of a producer task and a data-independent portion of a related consumer task. Furthermore, decoupling scheduling dependencies from data dependencies can hide any portion (including none or all) of the latency of the consumer overhead operations and/or any portion (including none or all) of one or more producer overhead operations.

The work scheduler/distribution unit 230 can resolve scheduling dependencies in any technically feasible fashion. In some embodiments, scheduling dependency logic 232 included in the work scheduler/distribution unit 230 implements a “pre-exit” mechanism that resolves or “releases” a scheduling dependency between a producer task and a related consumer task after the thread block launch for the producer task and prior to an optional memory flush for the producer task. Note that a memory flush is required for a producer task that has a least one data dependency with a related consumer task but is not necessarily required for a producer task that has no data dependencies with any related consumer tasks.

The scheduling dependency logic 232 can resolve a scheduling dependency based on any number and/or types of pre-exit criteria and/or pre-exit triggers. In some embodiments, the scheduling dependency logic 232 can determine one or more pre-exit criteria or pre-exit triggers to apply to each task in any technically feasible fashion. For instance, in some embodiments, the scheduling dependency logic 232 automatically applies a default pre-exit criteria and can override the default pre-exit criteria for each task based on the task descriptor, one or more instructions executed by the task, or any other technically feasible fashion.

In some embodiments, the scheduling dependency logic 232 can be configured to resolve or “release” a scheduling dependency between a producer task and a related consumer task after a task block launch for the producer task, when the last thread block of the producer task completes and prior to the start of an optional memory flush for the thread block, or when the producer task executes a pre-exit or “PREEXIT” instruction. In the same or other embodiments, the scheduling dependency logic 232 can support any number and/or types of scheduling dependency instructions instead of or in addition to any number and/or types of PREEXIT instructions.

In some embodiments, if a producer task executes a PREEXIT instruction that specifies one or more related consumer tasks, then the scheduling dependency logic 232 resolves the scheduling dependencies between the producer task and the specified related consumer tasks. In the same or other embodiments, if a producer task executes a PREEXIT instruction that does not specify any related consumer tasks, then the scheduling dependency logic 232 resolves all scheduling dependencies between the producer task and related consumer tasks.

In some embodiments, any number and/or types of PREEXIT instructions can be included in each of any number of producer tasks in any technically feasible fashion. In some embodiments, a PREEXIT instruction can be inserted into the kernel associated with a producer task via an API that is included in the programming platform software stack 122, a runtime, or a driver. In the same or other embodiments, the position of a PREEXIT instruction within a producer task can be fine-tuned to minimize launch latencies, optimize execution overlap(s) between the producer task and one or more related consumer tasks, optimize resource (e.g., SMs) tradeoffs, optimize any number and/or types of relevant tradeoffs, or any combination thereof.

In some embodiments, the work scheduler/distribution unit 230 implements a “bulk-release-acquire” mechanism to ensure that data dependencies between tasks are met. In the same or other embodiments, data dependencies between tasks are defined via “wait on latches” and “arrive at latches.” A data dependency between one or more producer tasks and one or more related consumer tasks is specified via a “dependency latch.” Each of the producer tasks of a dependency latch “arrives” at the dependency latch upon the task competition of the producer task. When all of the producer tasks of a dependency latch have arrived at the dependency latch, a corresponding data dependency is resolved or “released.” Each of the related consumer tasks of a dependency latch executes an “acquire-bulk” or “ACQBULK” instruction that waits for all the producer tasks to arrive at the dependency latch. Waiting for all the producer tasks to arrive at a dependency latch is also referred to herein as “waiting on” the dependency latch. In some embodiments, the work scheduler/distribution unit 230 can support any number and/or types of data dependency instructions instead of or in addition to any number and/or types of ACQBULK instructions.

The work scheduler/distribution unit 230 can implement the bulk-release-acquire mechanism in any technically feasible fashion. As shown, in some embodiments, the work scheduler/distribution unit 230 implements the bulk-release-acquire mechanism via a task dependency table 240 that is included in the work scheduler/distribution unit 230. In the same or other embodiments, the work scheduler/distribution unit 230 tracks any amount and/or type of data for each active task via the task dependency table 240. In some embodiments, the task dependency table 240 designates a task as an “active task” from the point-in-time at which all scheduling dependencies that the task has on related producer tasks are resolved to the point-in-time at which the task is complete.

As described previously herein, in some embodiments, a task is complete after the work scheduler/distribution unit 230 determines that all thread blocks of the task have finished executing and ensures that the SMs 260 have completed any required memory flush for the task. Advantageously, in some embodiments, because only active tasks are tracked via the task dependency table 240, the task dependency table 240 can have a relatively small finite size and is stored in an on-chip random-access memory.

The work scheduler/distribution unit 230 can track active tasks via the task dependency table 240 in any technically feasible fashion. In some embodiments, each row of the task dependency table 240 represents a different active consumer or active producer, and each column of the task dependency table 240 represents the status of a different task-related feature. After determining that all scheduling dependencies for a task have been resolved and the task is, therefore, an active task, the work scheduler/distribution unit 230 assigns a row of the task dependency table 240 to the task. The work scheduler/distribution unit 230 initializes and updates the entries of the task dependency table 240 to reflect the status of the active task until the completion of the active task. After the completion of an active task, the work scheduler/distribution unit 230 deassigns and clears the corresponding row (and therefore all entries included in the row) of the task dependency table 240.

In some embodiments, the task dependency table 240 includes, without limitation, a “wait on latch” column and an “arrive at latch” column. Accordingly, the task dependency table 240 includes, without limitation, a wait on latch entry and an arrive at latch entry for each active task. In the same or other embodiments, when the work scheduler/distribution unit 230 adds an active task to the task dependency table 240, the work scheduler/distribution unit 230 specifies any dependency latch that the active task waits upon via a corresponding wait on latch entry and any dependency latch that the active task arrives at via the corresponding arrive at latch entry. For a given active task, the wait on latch entry therefore indicates any data dependencies on which the active task must wait, and the arrive at latch entry indicates any data dependencies that are automatically resolved when the active task completes.

In some embodiments, to enable consumer tasks to accurately determine the status of data dependencies on related producer tasks via the task dependency table 240, the work scheduler/distribution unit 230 ensures that the last thread block of each producer task is launched before the first thread block of any related consumer task is launched. Accordingly, if none of the arrive at latch entries in the task dependency table 240 specifies a dependency latch that a consumer task is waiting on, then the consumer task can correctly infer that all the producer tasks of the dependency latch have already arrived at the dependency latch and therefore the corresponding dependency is resolved.

The work scheduler/distribution unit 230 can ensure that the last thread block of each producer task is launched before the first thread block of any related consumer task is launched in any technically feasible fashion. For instance, in some embodiments, if a producer task produces data that is consumed by a related consumer task, then the work scheduler/distribution unit 230 or a device driver inserts a PREEXIT instruction specifying the related consumer task at the beginning of the related producer task.

In some embodiments, a consumer task that has a data dependency on one or more related producer tasks includes, sequentially and without limitation, an optional data-independent portion of the consumer task, an “acquire bulk” or “ACQBULK” instruction, and a data-dependent portion of the consumer task. A data-dependent portion of a task is also referred to herein as a “data-dependent set of instructions.” Executing the ACQBULK instruction causes the consumer task to read the wait on latch entry corresponding to the consumer task from the task dependency table 240 to determine the applicable dependency latch. The ACQBULK instruction then waits and blocks further execution of the consumer task until none of the arrive at latch entries in the task dependency table specify the dependency latch (and therefore the data dependency corresponding to the dependency latch is released or resolved). After the ACQBULK instruction determines that none of the arrive at latch entries in the task dependency table specify the dependency latch, the data-dependent portion of the consumer task executes.

### Producer Overhead Latency and Memory Latency

In some embodiments, to reduce the latency between when the first thread block of a task begins executing and a required memory flush for the task completes, the work scheduler/distribution unit 230 preemptively broadcasts a memory flush request to the SMs 260 executing the task. More specifically and in some embodiments, after launching the last thread block of a producer task that generates data consumed by one or more related consumer tasks, the work scheduler/distribution unit 230 broadcasts a memory flush request to all of the SMs 260 executing the producer task. In the same or other embodiments, the memory flush request causes each of the SMs 260 executing the producer task to automatically initiates a memory flush after all the thread block(s) of the producer task have finished executing.

In some other embodiments, the work scheduler/distribution unit 230 can broadcast a memory flush request to all of the SMs 260 executing the producer task via any number of intermediate units, and the techniques and functionality described herein are modified accordingly, For instance, in some embodiments, the work scheduler/distribution unit 230 broadcasts a memory flush request to all MPCs managing the SMs 260 executing the producer task. In the same or other embodiments, in response to the memory flush request, each MPC causes each SM in an associated set of SMs to execute a memory flush after all the thread blocks of the producer task executing on the set of SMs have completed.

In some embodiments, because the work scheduler/distribution unit 230 does not wait to receive thread block completion notifications from all of the SMs 260 executing a producer task before broadcasting a memory flush request to the SMs 260, the latency of the producer overhead operations can be reduced. More specifically, the latency of broadcasting the memory flush request can be hidden by the execution of the producer task. And the latency of communicating the last thread block completion notification for a producer task can be hidden by the latency of the memory flush for the producer task. As a result, the latency between when the last thread block of a task finishes executing and a required memory flush for the task completes can be reduced by the latency of a round-trip communication between the work scheduler/distribution unit 230 and the SMs 260. Preemptively broadcasting memory flush requests can therefore reduce each launch latency by the latency of a round-trip communication between the work scheduler/distribution unit 230 and the SMs 260.

In some embodiments, to further reduce launch latencies, the work scheduler/distribution unit 230 provides prefetch functionality that can initiate an instruction prefetch and/or a constant prefetch for each task prior to the task launch for the task. In some, the instruction prefetch retrieves any number of the instructions of the task from a memory and then caches the retrieved instructions in a cache that is accessible to the SMs 260, such as the L1.5 cache. In the same or other embodiments, the constant prefetch retrieves any number of the constants of the task from a memory and then caches the retrieved constants in a cache that is accessible to the SMs 260, such as the L1.5 cache.

In some embodiments, the work scheduler/distribution unit 230 automatically enables the prefetch functionality for each task. In some other embodiments, the work scheduler/distribution unit 230 enables each task to specify whether to enable the prefetch functionality for the task in any technically feasible fashion. For instance, in some embodiments, prefetch functionality can be optionally enabled for each task via a task descriptor.

In some embodiments, the prefetch functionality initiates both an instruction prefetch and a constant prefetch for each task after the work scheduler/distribution unit finishes processing the scheduling information for the task. In some embodiments, the instruction prefetch and the constant prefetch for a task can occur at least partially in parallel with each other, with the scheduling/load balancing, thread block launch, and execution of the task, with the execution, thread block completion, bulk-release, and memory flush of one or more related producer tasks, or any combination thereof.

Because the pre-exit mechanism can overlap the execution of both the instruction prefetch and the constant prefetch for a consumer task with the memory flush and execution of a related producer task, the work scheduler/distribution unit 230 can at least partially hide the memory latencies of both the instruction prefetch and the constant prefetch for the consumer task. In the same or other embodiments, the placement of a PREEXIT instruction within a producer task can be optimized to allow the work scheduler/distribution unit 230 to completely hide the memory latencies of both the instruction prefetch and the constant prefetch for a related consumer task.

Advantageously, the techniques described herein can enable the latencies of many major contributors to the launch latency between a producer task and a related consumer task can be hidden by other contributors to the launch latency, the execution of the producer task, and the execution of the related consumer task. The launch latency between the producer task and the related consumer task can therefore be reduced. And a latency of a critical path of sequential activities from the time at which the last thread block of the producer task begins executing to the time at which the first thread block of the consumer task finishes executing can be substantially decreased. Furthermore, the techniques described herein enable the execution of a producer task and a data-independent portion of a related consumer task to be overlapped in time. As a result, the latency of the critical path can even be less than the time needed to execute the producer task and the related consumer task.

### Reducing Critical Paths

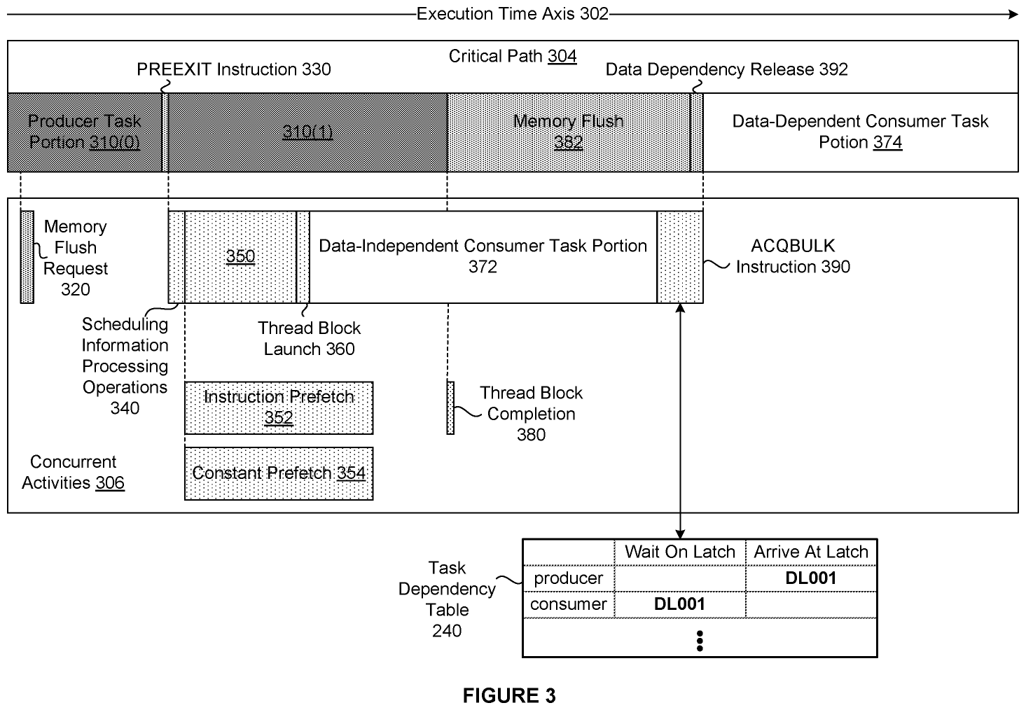

FIG. 3 is an example illustration of a critical path 304 associated with executing a producer task and a related consumer task on the parallel processor 130 of FIG. 2, according to various embodiments. The consumer task has both a scheduling dependency and a data dependency on the producer task. For explanatory purposes, any activities and dependencies associated with any other tasks executing on the parallel processor 130 are not depicted in FIG. 3.

The critical path 304 and concurrent activities 306 illustrate the execution of the producer task, the consumer task, producer overhead operations associated with the producer task, and consumer overhead operations associated with the consumer task. The critical path 304 is a sequence of task-related activities that span from the time at which the last thread block of the producer task begins executing through the time at which the first thread block of the consumer task finishes executing. The latencies of the task-related activities included in the critical path 304 contribute to the latency of the critical path 304. Concurrent activities 306 depicts the relative timings of task-related activities having latencies that are hidden by the latencies of task-related activities included in the critical path 304. Notably, the critical path 304 and the concurrent activities 306 illustrate optimizations achieved via the pre-exit mechanism, the bulk-release-acquire mechanism, a preemptive memory flush, and the prefetch functionality described previously herein in conjunction with FIG. 2.

For explanatory purposes, the task-related activities included in the critical path 304 and concurrent activities 306 are depicted along an execution time axis 302 but are not drawn to scale. The producer task is depicted via dark gray boxes, overhead activities associated with the producer task are depicted via medium gray boxes, overhead activities associated with the consumer task are depicted via light gray boxes, and the consumer task is depicted via white boxes.

As shown, in some embodiments, the producer task includes, without limitation, a producer task portion 310(0), a PREEXIT instruction 330, and a producer task portion 310(1). In the same or other embodiments, each of the producer task portion 310(0) and the producer task portion 310(1) includes, without limitation, one or more instructions. The consumer task included, without limitation, a data-independent consumer task portion 372 that is independent of data generated by the producer task, an ACQBULK instruction 390, and a data-dependent consumer task portion 374 that is dependent on data generated by the producer task.

In some embodiments, the critical path 304 begins at the point in time at which the work scheduler/distribution unit 230 launches the last thread block of the producer task onto one or more of the SMs 260 that are also referred to herein collectively as the “producer SM set.” As a result of the thread block launch for the producer task, the producer SM set executes the producer task. More specifically, the producer SM set sequentially executes the producer task portion 310(0), the PREEXIT instruction 330, and the producer task portion 310(1). In some embodiments, the producer task portion 310(0), the PREEXIT instruction 330, and the producer task portion 310(1) are included in the critical path 304.

As shown, after the work scheduler/distribution unit 230 launches the last thread block of the producer task onto the producer SM set, the work scheduler/distribution unit 230 broadcasts a memory flush request 320 to the producer SM set. The memory flush request 320 occurs while the producer SM set is executing the producer task portion 310(0). Advantageously, the latency of the memory flush request 320 is hidden by the latency of the execution of the producer task portion 310(0). The memory flush request 320 is therefore included in concurrent activities 306 and does not contribute to the latency of the critical path 304.

In some embodiments, in response to the execution of the PREEXIT instruction 330 by the producer SM set, the scheduling dependency logic 232 resolves the scheduling dependency between the producer task and the consumer task. Because the only task that the consumer task is dependent upon is the producer task, the work scheduler/distribution unit 230 determines that all the scheduling dependencies that the consumer task has on other tasks are resolved. The work scheduler/distribution unit 230 designates the consumer task as an active task, assigns a cleared row of the task dependency table 240 to the consumer task, and executes scheduling information processing operations 340 for the consumer task.

After assigning a cleared row of the task dependency table 240 to the consumer task, the work scheduler/distribution unit 230 initializes the row to reflect the data dependency that the consumer task has on the producer task. For explanatory purposes, FIG. 3 depicts an example of task dependency table 240 at a point-in-time when both the producer task and the consumer task are active. The data dependency between the producer task and the consumer task is specified via a dependency latch denoted “DL001” and neither the producer task nor the consumer task is associated with any other data dependencies. Accordingly, the wait on latch entry for the producer task is empty and the arrive at latch entry for the producer task specifies DL001. The work scheduler/distribution unit 230 initializes the wait on latch entry for the consumer task to specify DL001 and leaves the arrive at latch entry for the consumer task empty.

As shown, the work scheduler/distribution unit 230 executes the scheduling information processing operations 340 while the producer SM set executes the producer task portion 310(1). Advantageously, the latency of the scheduling information processing operations 340 is hidden by the latency of the execution of the producer task portion 310(1) The scheduling information processing operations 340 are therefore included in concurrent activities 306 and do not contribute to the latency of the critical path 304.

After the work scheduler/distribution unit 230 finishes executing the scheduling information processing operations 340, the work scheduler/distribution unit 230 initiates an instruction prefetch 352 for the consumer task, initiates a constant prefetch 354 for the consumer task, and executes scheduling/load balancing operations 350 for the workload of the consumer task. As shown, the execution of the producer task portion 310(1) completely overlaps the instruction prefetch 352, the constant prefetch 354, and the scheduling/load balancing operations 350. The memory latency of the latency of instruction prefetch 352 and the constant prefetch 354 as well as the latency of the scheduling/load balancing operations 350 are therefore hidden by the latency of the execution of the producer task portion 310(1). Accordingly, the instruction prefetch 352, the constant prefetch 354, and the scheduling/load balancing operations 350 are included in concurrent activities 306 and do not contribute to the latency of the critical path 304.

After the work scheduler/distribution unit 230 finishes executing the scheduling/load balancing operations 350, the work scheduler/distribution unit 230 executes a thread block launch 360 for the consumer task. During the thread block launch 360, the work scheduler/distribution unit 230 launches the thread blocks of the consumer task onto one or more of the SMs 260 that are also referred to herein collectively as the “consumer SM set.” As a result of the thread block launch 360, the consumer SM set executes the consumer task. More specifically, the consumer SM set sequentially executes the data-independent consumer task portion 372, the ACQBULK instruction 390, and the data-dependent consumer task portion 374.

As shown, in some embodiments, the work scheduler/distribution unit 230 executes the thread block launch 360 while the producer SM set executes the producer task portion 310(1). The latency of the thread block launch 360 is therefore hidden by the latency of the execution of the producer task portion 310(1). The thread block launch is included in the concurrent activities 306 and does not contribute to the latency of the critical path 304.

While the consumer SM set executes the data-independent consumer task portion 372, the producer SM set finishes executing the producer task portion 310(1). As the thread blocks of the producer task finish executing, the producer SM set transmits thread block completion notifications (depicted as thread block completion 380) to the work scheduler/distribution unit 230. The producer SM set also executes a memory flush 382 for the producer task in response to the memory flush request 320.

As shown, the latency of the execution of the data-independent consumer task portion 372 is hidden by the latencies of the execution of the producer task portion 310(1) and the memory flush 382. And the latency of the thread block completion 380 is hidden by the latency of the memory flush 382. The data-dependent consumer task portion 372 and the thread block completion 380 are included in the concurrent activities 306, and the latencies of the data-dependent consumer task portion 372 and the thread block completion 380 do not contribute to the latency of the critical path 304. By contrast, the memory flush 382 is included in the critical path 304 and therefore the latency of the memory flush 382 contributes to the latency of the critical path 304.

In some embodiments, during the memory flush 382, the consumer SM set finishes executing the data-independent consumer task portion 372 and begins to execute the ACQBULK instruction 390. In some embodiments, the ACQBULK instruction 390 reads the arrive at latch entry for the consumer task in the task dependency table 240 to determine that the relevant dependency latch is DL001. The ACQBULK instruction then reads the arrive at latch column to determine whether the producer task(s) associated with DL001 have arrived at DL001. Because the arrive at column entry for the producer task specifies DL001, the ACQBULK instruction waits until the work scheduler/distribution unit 230 resolves the dependency corresponding to DL001 and clears DL001 from the arrive at column.

As the SMs 260 in the producer memory set complete the memory flush 382, the SMs 260 transmit memory flush completion notifications to the work scheduler/distribution unit 230. After receiving the last memory flush completion notification, the work scheduler/distribution unit 230 determines that the consumer task is no longer active and executes a data dependency release 392. During the data dependency release 392, the work scheduler/distribution unit 230 deassigns and clears the row of the task dependency table 240 assigned to the producer task. As a result, the ACQBULK instruction 390 completes, and the producer SM set executes the data-dependent consumer task portion 374.

As shown, the latency of the ACQBULK instruction 390 is hidden by the latencies of the memory flush 382 and the data dependency release 392. The ACQBULK instruction 390 is included in the concurrent activities 306, and the latency of the ACQBULK instruction 390 does not contribute to the latency of the critical path 304. By contrast, the data dependency release 392 and the data-dependent consumer task portion 374 are included in the critical path 304 and therefore the latencies of the data dependency release 392 and the data-dependent consumer task portion 374 contribute to the latency of the critical path 304.

As persons skilled in the art will recognize, in various embodiments, the activities that are included in a critical path and the subset of those activities that determine the launch latency can vary. For instance, in some embodiments, the SMs 260 are fully occupied until the thread blocks of the producer task complete, and therefore the thread block completion of the producer task, the thread block launch of the consumer task, and the execution of the data-independent portion of the consumer task are included in the critical path, In the same or other embodiments, the latencies of the thread block completion of the producer task, the thread block launch of the consumer task, and the execution of the data-independent portion of the consumer task hide the latency of the memory flush for the producer task.

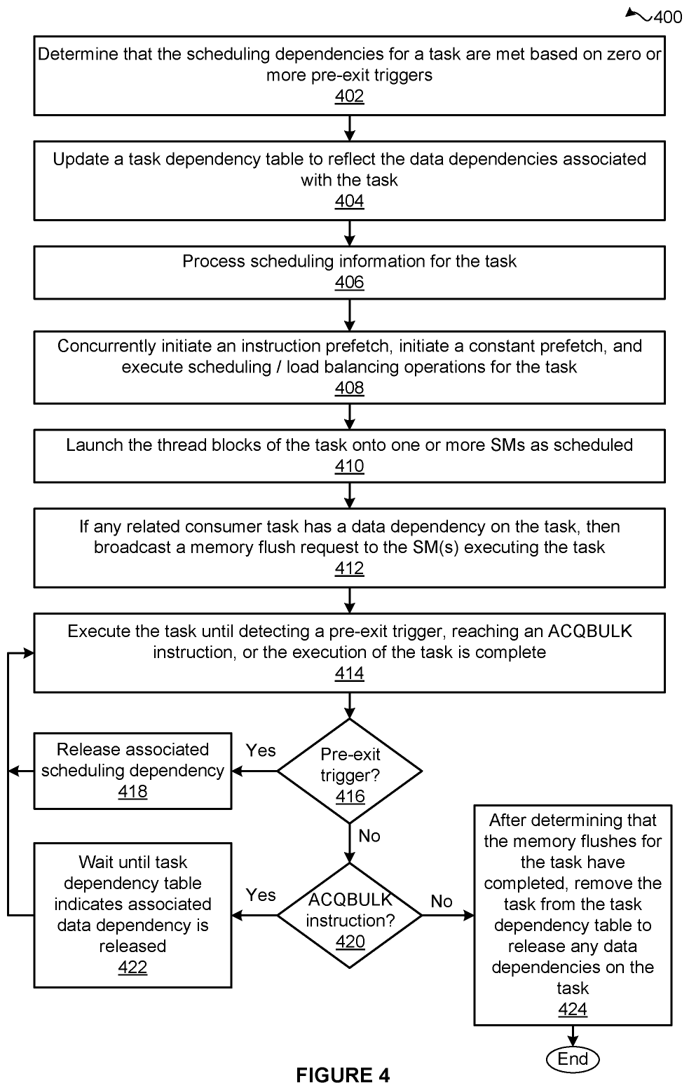

FIG. 4 is a flow diagram of method steps for executing tasks on a parallel processor, according to various embodiments. Although the method steps are described with reference to the systems of FIGS. 1-3, persons skilled in the art will understand that any system configured to implement the method steps, in any order, falls within the scope of the present disclosure,

As shown, a method 400 begins at step 402, where the work scheduler/distribution unit 230 determines that the scheduling dependencies for a task have been met based on zero or more pre-exit triggers. At step 404, the work scheduler/distribution unit 230 updates a task dependency table 240 to reflect the data dependencies associated with the task. At step 406, the work scheduler/distribution unit 230 processes scheduling information for the task. At step 408, the work scheduler/distribution unit 230 concurrently initiates an instruction prefetch, initiates a constant prefetch, and executes scheduling/load balancing operations for the task.

At step 410, the work scheduler/distribution unit 230 launches the thread blocks of the task onto one or more of the SM 260 as scheduled. At step 412, if any related consumer task has a data dependency on the task, then the work scheduler/distribution unit 230 broadcasts a memory flush request to the SM(s) 260 executing the task. At step 414, the SM(s) 260 execute the task until the work scheduler/distribution unit 230 detects a pre-exit trigger, the SM(s) 260 reach an ACQBULK instruction, or the task is complete.

At step 416, the work scheduler/distribution unit 230 determines whether the work scheduler/distribution unit 230 has detected a pre-exit trigger. If, at step 416, the work scheduler/distribution unit 230 determines that the work scheduler/distribution unit 230 has detected a pre-exit trigger, then the method 400 proceeds to step 418. At step 418, the work scheduler/distribution unit 230 releases the scheduling dependency associated with the pre-exit trigger. The method 400 then returns to step 414, where the SM(s) 260 execute the task until the work scheduler/distribution unit 230 detects a pre-exit trigger, the SM(s) 260 reach an ACQBULK instruction, or the task is complete.

If, however, at step 416, the work scheduler/distribution unit 230 determines that the work scheduler/distribution unit 230 has not detected a pre-exit trigger, then the method 400 proceeds directly to step 420. At step 420, the SM(s) 260 determine whether the SM(s) 260 have reached an ACQBULK instruction. If, at step 420, the SM(s) 260 determine that the SM(s) 260 have reached an ACQBULK instruction, then the method 400 proceeds to step 422. At step 422, the SM(s) 260 wait until the task dependency table 240 indicates that the associated data dependency is released. The method 400 then returns to step 414, where the SM(s) 260 execute the task until the work scheduler/distribution unit 230 detects a pre-exit trigger, the SM(s) 260 reach an ACQBULK instruction, or the task is complete.

If, however, at step 420, the SM(s) 260 determine that the SM(s) 260 have not reached an ACQBULK instruction, then the method 400 proceeds to step 424. At step 424, after determining that the memory flushes for the task have been completed, the work scheduler/distribution unit 230 removes the task from the task dependency table 240 to release any data dependencies on the task. The method 400 then terminates.

In sum, the disclosed techniques can be used to reduce launch latencies and critical paths of tasks executing on parallel processors. In some embodiments, a work scheduler/distribution unit included in a parallel processor decouples scheduling dependencies and data dependencies. After determining that a task has no unresolved scheduling dependencies on any related producer tasks, the work scheduler/distribution unit adds any data dependencies associated with the task to a task dependency table. The work scheduler/distribution unit then processes scheduling information for the task. Subsequently, the work scheduler/distribution unit initiates an instruction prefetch for the task, initiates a constant prefetch for the task, and schedules and load balances the task over one or more SMs. The work scheduler/distribution unit then launches the thread blocks of the task on the SM(s) as scheduled. Subsequently, the work scheduler/distribution unit broadcasts a memory flush to the associated SM(s).

As the task executes, the work scheduler/distribution unit can detect a pre-exit trigger (e.g., a PREEXIT instruction) and/or the SM(s) can reach an ACQBULK instruction. In response to a pre-exit trigger, the work scheduler/distribution unit resolves an associated scheduling dependency that one or more related consumer tasks have on the task. Accordingly, the pre-exit trigger can enable the work scheduler/distribution unit to schedule zero or more related consumer tasks.

To execute an ACQBULK instruction, the task waits until the task dependency table indicates that a corresponding data dependency that the task has on a related consumer task is resolved. Accordingly, an ACQBULK instruction can temporarily pause the execution of the task. After the thread blocks executing the task complete, the associated SMs execute a memory flush as previously requested and transmit memory flush completion notifications to the work scheduler/distribution unit. After the work scheduler/distributor receives the last memory flush completion notification, the work scheduler/distribution unit removes the task from the task dependency table. Removing the task from the task dependency table enables related consumer task(s) to infer that any data dependency on the task has been resolved.

At least one technical advantage of the disclosed techniques relative to the prior art is that, with the disclosed techniques, a processor can schedule, launch, and execute an initial portion of a consumer task while continuing to execute a related producer task. In that regard, with the disclosed techniques, scheduling dependencies can not only be decoupled from data dependencies but can also be resolved during the execution of producer tasks. Furthermore, with the disclosed techniques, data dependencies can be resolved during the execution of consumer tasks. Resolving dependencies during instead of between the execution of tasks allows the execution of consumer tasks, producer tasks, and associated overhead instructions to be overlapped. As a result, launch latencies and therefore the overall time required to execute software applications can be reduced. These technical advantages provide one or more technical advancements over prior art approaches.

Any and all combinations of any of the claim elements recited in any of the claims and/or any elements described in this application, in any fashion, fall within the contemplated scope of the various embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random-access memory, a read-only memory, an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A parallel processor comprising:
a plurality of multiprocessors; and
a work scheduler/distribution unit coupled to the plurality of multiprocessors that:
launches a first task on a first subset of the plurality of multiprocessors;
prior to launching a second task, determines that a first scheduling dependency associated with the second task is unresolved, wherein the first scheduling dependency specifies that the second task is dependent on the first task;
before the completion of the first task, resolves the first scheduling dependency based on a pre-exit trigger; and
in response to the resolution of the first scheduling dependency, launches the second task on a second subset of the plurality of multiprocessors.

2. The parallel processor of claim 1, wherein the pre-exit trigger comprises the execution of a scheduling dependency instruction included in the first task.

3. The parallel processor of claim 1, wherein the pre-exit trigger comprises the completion of the execution of the first task.

4. The parallel processor of claim 1, wherein during the execution of the first task, the work scheduler/distribution unit further broadcasts a memory flush request to the first subset of the plurality of multiprocessors.

5. The parallel processor of claim 1, wherein subsequent to the execution of the first task, the work scheduler/distribution unit further:
determines that each multiprocessor included in the first subset of the plurality of multiprocessors has completed a memory flush; and
indicating a release of a first data dependency associated with the second task, wherein the first data dependency specifies that the second task is dependent on data produced by the execution of the first task, and wherein the release of the first data dependency enables an execution of the second task to proceed past a data dependency instruction that blocks the execution of the second task until the release of the first data dependency.

6. The parallel processor of claim 5, wherein the data dependency instruction determines that the first data dependency has been released based on a task dependency table.

7. The parallel processor of claim 1, wherein prior to launching the second task, the work scheduler/distribution unit further initiates a retrieval of one or more instructions associated with the second task from a memory.

8. The parallel processor of claim 1, wherein prior to launching the second task, the work scheduler/distribution unit further initiates a retrieval of one or more constants associated with the second task from a memory.

9. The parallel processor of claim 1, wherein the pre-exit trigger comprises a scheduling dependency instruction, and the first task comprises a first plurality of instructions that proceed the scheduling dependency instruction, the scheduling dependency instruction, and a second plurality of instructions that follow the scheduling dependency instruction.

10. The parallel processor of claim 1, wherein the second task comprises a data-independent set of instructions that precede a data dependency instruction, the data dependency instruction that is associated with a first data dependency of the second task on the first task, and a data-dependent set of instructions that follow the data dependency instruction.

11. A computer-implemented method for executing tasks on a parallel processor, the method comprising:
launching a first task on a first subset of a plurality of multiprocessors;
prior to launching a second task, determining that a first scheduling dependency associated with the second task is unresolved, wherein the first scheduling dependency specifies that the second task is dependent on the first task;
before the completion of the first task, resolving the first scheduling dependency based on a pre-exit trigger; and
in response to the resolution of the first scheduling dependency, launching the second task on a second subset of the plurality of multiprocessors.

12. The computer-implemented method of claim 11, wherein the pre-exit trigger comprises the execution of a scheduling dependency instruction included in the first task.

13. The computer-implemented method of claim 11, wherein the pre-exit trigger comprises the completion of the launch of the first task.

14. The computer-implemented method of claim 11, further comprising, broadcasting a memory flush request to the first subset of the plurality of multiprocessors during the execution of the first task.

15. The computer-implemented method of claim 11, further comprising, subsequent to the execution of the first task:
determining that each multiprocessor included in the first subset of the plurality of multiprocessors has completed a memory flush; and
indicating a release of a first data dependency associated with a third task, wherein the first data dependency specifies that the third task is dependent on data produced by the execution of the first task, and wherein the release of the first data dependency enables an execution of the third task to proceed past a data dependency instruction that blocks the execution of the third task until the release of the first data dependency.

16. The computer-implemented method of claim 15, wherein indicating the release of the first data dependency comprises updating a task dependency table to remove one or more entries associated with the first task.

17. The computer-implemented method of claim 11, further comprising, prior to launching the second task, initiating a retrieval of one or more instructions associated with the second task from a memory.

18. The computer-implemented method of claim 11, further comprising, prior to launching the second task, initiating a retrieval of one or more constants associated with the second task from a memory.

19. The computer-implemented method of claim 11, wherein the pre-exit trigger comprises a scheduling dependency instruction, and the first task comprises a first plurality of instructions that precede the scheduling dependency instruction, the scheduling dependency instruction, and a second plurality of instructions that follow the scheduling dependency instruction.

20. A system comprising:
a memory that stores a plurality of task descriptors; and
a work scheduler/distribution unit coupled to the memory that:
launches a first task on a first subset of a plurality of multiprocessors based on a first task descriptor included in the plurality of task descriptors;
prior to launching a second task, determines that a first scheduling dependency associated with the second task is unresolved, wherein the first scheduling dependency specifies that the second task is dependent on the first task;
before the completion of the first task, resolves the first scheduling dependency based on a pre-exit trigger; and
in response to the resolution of the first scheduling dependency, launches the second task on a second subset of the plurality of multiprocessors based on a second task descriptor included in the plurality of task descriptors.
